(19) United States
(12) Patent Application Publication
(10) Pub. No.: US 2011/0208854 A1
(43) Pub. Date: Aug. 25, 2011

(54) DYNAMIC TRAFFIC CONTROL USING FEEDBACK LOOP

(75) Inventors: JIAN ZHANG, SAMMAMISH, WA (US); LIDA LI, REDMOND, WA (US); CHRISTOPHER ANTHONY CLARK, BELLEVUE, WA (US); CHRISTOPHER J. ANTOS, BELLEVUE, WA (US); AMBROSE THOMAS TREACY, WOODINVILLE, WA (US); JAMES RICHARD STURMS, SEATTLE, WA (US)

(73) Assignee: MICROSOFT CORPORATION, REDMOND, WA (US)

(21) Appl. No.: 12/708,673

(22) Filed: Feb. 19, 2010

(51) Int. Cl. G06F 15/173; G06F 15/16

(52) U.S. Cl. 709/224; 709/230

(57) ABSTRACT

A feedback loop is created between a server and clients that provides the clients with health information of the server to assist in client-server traffic control. Health information is calculated for the server that measures a current health of the server. The health information is automatically provided to a client by the server in response to a request made by the client. The clients can utilize the received health information to determine when to request resources from the server.

### BACKGROUND

In a typical client-server environment, the server manages a set of resources and provides the ability to the clients to find and interact with a resource. For example, a file server provides the ability for users to store and look up files on the server. In some cases, numerous incoming requests from clients to the server can cause resource contention resulting in reduced system throughput and a degraded client experience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A feedback loop is created between a server and clients that provides the clients with health information of the server to assist in client-server traffic control. Health information is calculated for the server that measures a current health of the server. The health information is automatically provided to a client by the server in response to a request made by the client. The clients can utilize the received health information to determine when to request resources from the server.

### BRIEF DESCRIPTION OF THE DRAWINGS

FIG. 1 illustrates an exemplary computing environment;

FIG. 2 shows a system for determining a health of a server and providing health information of the server to one or more clients;

FIG. 3 illustrates a process for providing a health score of a server to a client; and

FIG. 4 shows an illustrative process for determining a current health score for the server.

### DETAILED DESCRIPTION

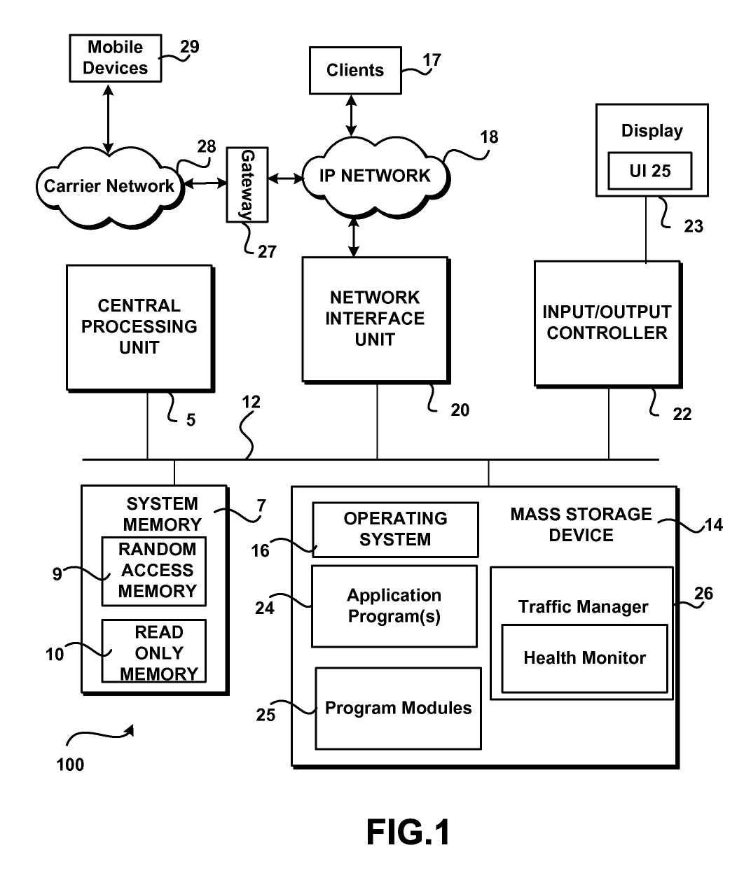

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24, other program modules 25, and traffic manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to an IP phone, a display screen 23, a printer, or other type of output device.

Carrier network 28 is a network responsible for communicating with mobile devices 29. The carrier network 28 may include both wireless and wired components. For example, carrier network 28 may include a cellular tower that is linked to a wired telephone network. Typically, the cellular tower carries communication to and from mobile devices, such as cell phones, notebooks, pocket PCs, long-distance communication links, and the like. Gateway 27 routes messages between carrier network 28 and IP Network 18.

As mentioned briefly above, a number of program modules and data files may be stored in the mass storage device 14 and RAM 9 of the computer 100, including an operating system 16 suitable for controlling the operation of a computer, such as WINDOWS SERVER® or the WINDOWS 7® operating system from MICROSOFT CORPORATION of Redmond, Wash. The mass storage device 14 and RAM 9 may also store one or more program modules. In particular, the mass storage device 14 and the RAM 9 may store one or more application programs 24 and program modules 25.

Traffic manager 26 is configured to determine health information for computer 100 using the health monitor and provide the health information to clients. The clients can use the health information in determining when to send requests to the server. Generally, a client (such as client 17) sends a request to the server (i.e. computer 100) to perform an action such as a request for a resource. The server handles the request and along with the response to the client also sends the current health information for the server to the client. The health monitor is configured to determine a health score of the server based on performance counter values associated with the computer. According to one embodiment, an average, such as an Exponential Moving Average (EMA) is used to smooth out the spikes in the performance counter values while still giving more weight to the recent performance samples in calculating the performance counter values. For example, samples for the various performance counters being measured can be taken every five seconds on the server for a period of time. According to one embodiment, the health monitor continually measures the health of the server. According to another embodiment, the health is monitored on a different basis, such as being monitored at predetermined times according to a schedule and/or triggered on the occurrence of an event, such as receiving a request from the client, and the like. While traffic manager 26 is illustrated as an independent program, the functionality may be integrated into other software and/or hardware. The operation of traffic manager 26 is described in more detail below. User Interface 25 may be utilized to interact with traffic manager 26 and/or application programs 24.

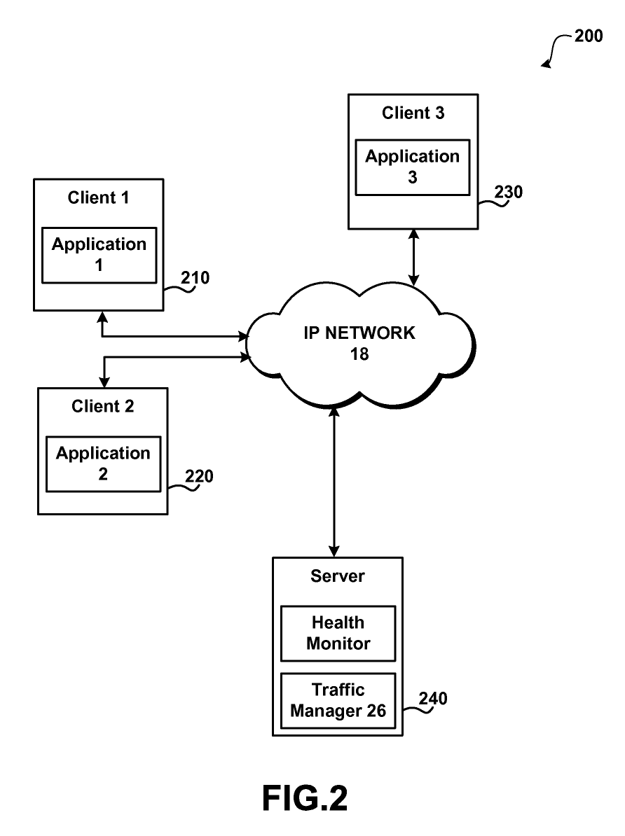

FIG. 2 shows a system for determining a health of a server and providing health information of the server to one or more clients. As illustrated, system 200 includes client 1 (210), client 2 (220), client 3 (230) and Server 240. Clients 1-3 are coupled to server 240 through IP Network 18. Each of the clients includes an application (applications 1-3) that is associated with requesting actions to be performed by server 240. Traffic manager 26 is used in determining the health of server 240. As briefly discussed above, traffic manager 26 uses the health monitor to monitor performance counters and determine a current health score for the server and then provide the health score to the client. According to one embodiment, traffic manager 26 provides the health score automatically to the client when the response to the client's request is sent to the client. For example, current health information, such as a current health score, may be placed within a header of the response provided to the client or in some other location within the response. Providing the health information along with the response to the client's request reduces a number of roundtrips required to provide the health information to the server. Additionally, the client does not need to specifically request the health information of the server. Instead, the health score is provided to the client with the response to the request. According to one embodiment, the health information is provided to the client along with each response sent to the client. Other methods of providing the health information may also be utilized. For example, the server could provide the health information: after a predetermined amount of time has elapsed since sending the last health information to the client; after a predetermined number of requests have been processed by the server that relate to the client; and the like.

During operation, clients 1-3 receive health information through IP network 18 from the server. This health information allows each client to be aware of the health of the server and schedule its requests to the server appropriately. The health information can include different information. For example, the health information could be a health score and/or could include other health information for the server including but not limited to, CPU usage, memory usage, and the like.

As discussed above, health monitor is configured to determine the health of the server. According to one embodiment, the health monitor determines the health of the server periodically (e.g. 1 second, five seconds, ten seconds, one minute, etc). This monitoring frequency may be fixed or variable as well as being changed by an authorized user. For instance, during certain periods the health of the server could be checked every 5 seconds during one period and every minute during another period.

For purposes of illustration, assume that application 1 on client 1 requests an action to be performed by server 240 (e.g. retrieving data, writing a value to a data store, etc.). After server 240 has performed the action, server 240 provides the most current health information calculated by the health monitor to client 1 along with the response to the client's request. Before a subsequent request, the client may utilize the health information to determine when to send a request to server 240. For example, during some periods the health of the server may be very good during which time the client may send requests as frequently as needed. During other times, the server's health may have degraded thereby causing the client to possibly slow the frequency of requests it sends to the server.

According to one embodiment, the health information that is provided to client is a health value that is between 0 and 1. Other ranges and/or other information may be provided. For example, the information could provide detailed information about the server's current resource use or the information could be somewhere between the single value and the detailed information. The health information may be a current snapshot of the health of the server or an average of the health of the server. According to one embodiment, an Exponential Moving Average (EMA) is utilized to track various performance counters on the server. The number of samples can be preset and/or configurable. For example, the number of samples could be 6, 12, 24, 100, and the like. An exemplary formula for calculating the EMA is EMA(current)=((Value(current)−EMA(prev))×Multiplier)+EMA(prev), where the Multiplier=2/(N+1). EMA is directed at smoothing out the spikes in the performance counter readings while still giving more weight to the recent performance samples. The higher value of the multiplier, the more weight is given to the recent values.

The example below shows a CPU trace for a program that consists of 24 samples and its EMA calculations. In the illustrated example, a 12-sample window (N=12) is used to calculate the average. Exp. N=12, the Multiplier=2/(12+1)=0.1538. In addition, the simple moving average (SMV) value of the first 12 samples is used to set up the exponential calculation.

| NO. | Value | EMA-12 |
|---|---|---|
| 1 | 40.00 | |
| 2 | 32.50 | |
| 3 | 57.50 | |
| 4 | 73.75 | |
| 5 | 69.06 | |
| 6 | 47.50 | |
| 7 | 42.97 | |
| 8 | 26.10 | |
| 9 | 46.41 | |
| 10 | 58.28 | |
| 11 | 24.69 | |
| 12 | 50.16 | 47.41 |
| 13 | 33.28 | 45.24 |
| 14 | 37.11 | 43.99 |
| 15 | 58.36 | 46.20 |
| 16 | 77.65 | 51.04 |
| 17 | 84.32 | 56.16 |
| 18 | 57.98 | 56.44 |
| 19 | 51.91 | 55.74 |
| 20 | 59.82 | 56.37 |
| 21 | 44.24 | 54.50 |
| 22 | 58.41 | 55.10 |
| 23 | 45.16 | 53.57 |
| 24 | 64.22 | 55.21 |

Many different performance counters may be measured on the server. For example, performance counters may measure CPU usage, memory usage, wait time, queue length of requests, and the like.

After obtaining the determined performance counters, each performance counter is normalized and mapped to a range of values. According to one embodiment, each performance counter is mapped to one of ten different values. The mapping is used to normalize the way to measure the server load using different performance counters since performance counters generally have different units of measure. As a result, scores of different performance counters are obtained. For example: CPU Score (S_{CPU}), Memory Score (S_{Memory}), ASP.NET Queue Length Score(S_{Queue}), and ASP.NET Wait Time in the Queue (S_{WaitTime}).

The following table illustrates an exemplary mapping of values.

| | EMA Values | | | |
|---|---|---|---|---|
| | | | | ASP.NET Wait |
| | | Available | ASP.NET | Time in the |
| Score | CPU % | Memory (MB) | Queue Length | Queue (ms) |
| 0.1 | [0%, 10%) | >=2500 | [0, 1) | [0, 100) |
| 0.2 | [10%, 20%) | [2000, 2500) | [1, 20) | [100, 500) |
| 0.3 | [20%, 30%) | [1750, 2000) | [20, 50) | [500, 1000) |
| 0.4 | [30%, 35%) | [1500, 1750) | [50, 100) | [1000, 5000) |
| 0.5 | [35%, 40%) | [1250, 1500) | [100, 150) | [5000, 10000) |
| 0.6 | [40%, 50%) | [1000, 1250) | [150, 200) | [10000, 15000) |
| 0.7 | [50%, 65%) | [800, 1000) | [200, 300) | [15000, 20000) |
| 0.8 | [65%, 80%) | [500, 800) | [300, 400) | [20000, 25000) |
| 0.9 | [80%, 99%) | [20, 500) | [400, 500) | [25000, 30000) |
| 1.0 | >=99% | [0, 20) | >=500 | >=30000 |

Other mappings may be implemented depending on the performance counters being measured. For example, different performance counters may require different curve fitting. Further, the values in the mapping table may be updated to further tune the performance and provide a more accurate health score.

After mapping the performance counters, a health of the server is determined. According to one embodiment, the maximum mapped value that is calculated for a performance counter is used as the server's health score. Other values may be used. For example, the mapped values may be averaged, different counters may be given more weight in calculating the score, and the like. Once the current health score of the server is determined it is provided to the client when the server sends back the response to the request made by the client.

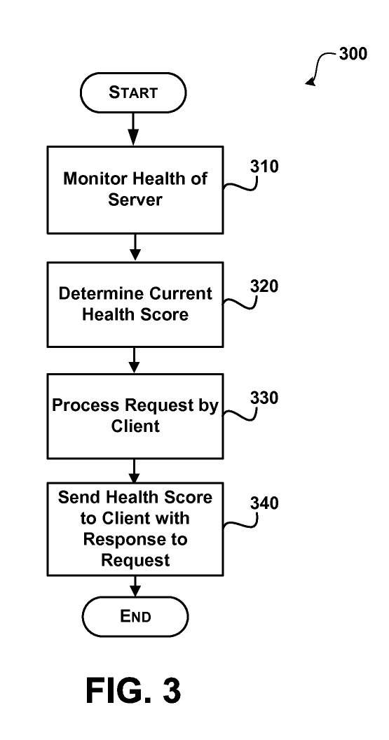

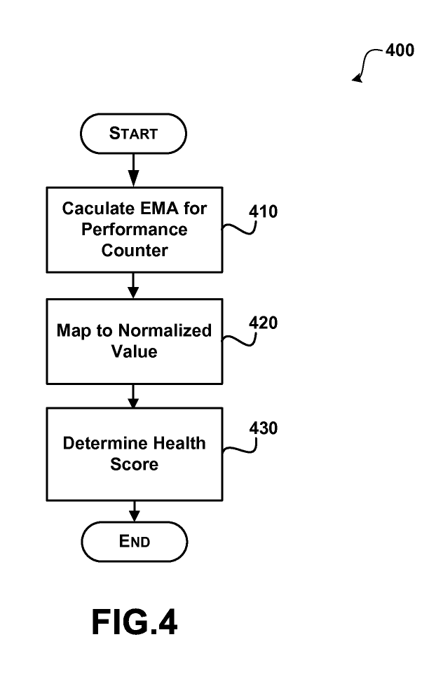

Referring now to FIGS. 3-4, illustrative processes for traffic control using a feedback loop between a client and server will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

Referring now to FIG. 3, a process 300 for providing a health score of a server to a client is shown.

After a start block, the process moves to operation 310, where the health of the server is monitored. As discussed above, the health of the server may be continually monitored such that a current health score for the server may be more quickly obtained or on some other basis. Different performance counters of the server may be monitored. For example, memory usage, CPU usage, wait time, processing time, and the like may be monitored.

Moving to block 320, the current health score for the server is determined. According to one embodiment, each averaged performance counter value is mapped to a normalized value such that the values are more easily compared. The health score may be computed many different ways. For example, the largest normalized value may be used as a health score, the normalized values may be averaged, more weight may be assigned to different performance counters and the like.

Transitioning to operation 330, the server processes a received request from a client. The request may relate to many different items, such as requesting a resource or performing some other action.

Flowing to operation 340, the health score is sent to the client along with the response to the request initiated by the client. According to one embodiment, the health score is placed within a header of the response message. The health score may also be placed in other locations within the response. For example, the response may be encoded within the body of the response.

The process then flows to an end block and returns to processing other actions.

FIG. 4 shows an illustrative process for determining a current health score for the server.

After a start operation, the process flows to operation 410 where the Exponential Moving Average (EMA) for each monitored performance counter is determined The EMA is used to smooth out the spikes in the performance counter values while still giving more weight to the recent performance samples in calculating the performance counter values. A different number of samples may be utilized.

Moving to operation 420, each of the calculated EMA's is mapped to a normalized value. The mapping is used to normalize the way to measure the server health using different performance counters since performance counters generally have different units of measure. The table used for the mapping may be fixed and/or updated to further refine the mapping of the values.

Flowing to operation 430, the health score for the server is determined based on the mapped values. According to one embodiment, the health score is the largest value of the normalized performance counters.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for dynamic client-server traffic control utilizing a feedback loop between a server and a client, comprising:
determining a health of a server;
receiving a request from a client on the server to perform an action;
processing the request from the client using the server; and
automatically including health information for the server within a response to the client; wherein the response relates to the request received from the client.

2. The method of claim 1, wherein determining the health of the server comprises calculating different performance counters for the server and determining a health score based on the calculated different performance counters.

3. The method of claim 2, wherein the health score of the server is specified as a single value.

4. The method of claim 2, wherein the health score for the server is based on an average of a predetermined number of values for each of the different performance counters.

5. The method of claim 4, wherein the average is an Exponential Moving Average.

6. The method of claim 4, further comprising using a mapping table to normalize the different performance counter values.

7. The method of claim 4, further comprising using a mapping table to normalize the different performance counter values and basing the health score on the largest normalized value for the different performance counter values.

8. The method of claim 2, wherein the different performance counters comprise at least two of: a CPU load; a memory usage, a wait time and a queue length of requests.

9. The method of claim 1, wherein the health score is placed within a header of the response.

10. A computer-readable storage medium having computer-executable instructions for dynamic client-server traffic control utilizing a feedback loop between a server and a client, comprising:
automatically and periodically determining a health of a server;
in response to providing a response to a client, inserting health information for the server within the response; and
sending the response to the client.

11. The computer-readable storage medium of claim 10, wherein determining the health of the server comprises calculating different performance counters for the server and determining a health score based on the calculated different performance counters.

12. The computer-readable storage medium of claim 11, wherein the health score for the server is based on an Exponential Moving Average of a predetermined number of values for each of the different performance counters.

13. The computer-readable storage medium of claim 12, further comprising using a mapping table to normalize the different performance counter values.

14. The computer-readable storage medium of claim 11, further comprising using a mapping table to normalize the different performance counter values and weighting the largest normalized value for the different performance counter values the highest when determining the health score.

15. The computer-readable storage medium of claim 11, wherein the different performance counters comprise at least two of: a memory usage, a wait time and a queue length of requests.

16. The computer-readable storage medium of claim 10, wherein the health score is placed within a header of the response.

17. An apparatus for dynamic traffic control, comprising:
a network connection that is configured to connect to the IP network;
a processor, memory, and a computer-readable storage medium;
an operating environment stored on the computer-readable storage medium and executing on the processor; and
a traffic manager operating under the control of the operating environment and operative to:
automatically and periodically determine a health of the apparatus;
in response to providing a response from the apparatus to a client, inserting health information for the apparatus within the response; and
sending the response to the client over the IP network.

18. The apparatus of claim 17, wherein determining the health of the apparatus comprises calculating different performance counters comprising at least a processor usage for the apparatus and determining a health score based on an average of the calculated different performance counters.

19. The apparatus of claim 18, further comprising using a mapping table to normalize the different performance counter values.

20. The apparatus of claim 18, further comprising using a mapping table to normalize the different performance counter values and weighting the largest normalized value for the different performance counter values the highest when determining the health score.
